(19) United States
(12) Patent Application Publication
(10) Pub. No.: US 2010/0028720 A1
(43) Pub. Date: Feb. 4, 2010

(54) SPUTTERING APPARATUS, SPUTTERING METHOD AND METHOD OF MANUFACTURING MAGNETIC RECORDING MEDIUM

(75) Inventors: Koji Nishida, Higashine (JP); Katsunori Takahashi, Higashine (JP); Shin-ichiro Matsuo, Higashine (JP)

Correspondence Address: GREER, BURNS & CRAIN, 300 S WACKER DR, 25TH FLOOR, CHICAGO, IL, 60606, US

(73) Assignee: SHOWA DENKO K.K., Tokyo (JP)

(21) Appl. No.: 12/493,754

(22) Filed: Jun. 29, 2009

(30) Foreign Application Priority Data
Aug. 1, 2008 (JP) 2008-199838

(51) Int. Cl. G11B 5/82; G11B 5/851

(52) U.S. Cl. 428/826; 204/298.15; 204/192.12; 204/298.17

(57) ABSTRACT

A sputtering apparatus includes a substrate holding section that holds a substrate on which surface a film is formed; a plate-shaped target made of a material of the film and disposed in a position facing the surface of the substrate in an atmosphere of a predetermined gas; a magnetic field generator that is disposed on a side, opposed to the substrate side, of the target, that generates a magnetic field having an arc shape with a vertex reaching the substrate side, and that rotates the magnetic field along the target; a power source that applies, to the target, voltage of a polarity causing ions of the predetermined gas to head for the target; and a magnetic plate that is inserted between the target and the magnetic field generator and that limits the magnetic field reaching the target at a part of a rotation path of the magnetic field.

### CROSS-REFERENCE TO RELATED APPLICATION

This application is based upon and claims the benefit of priority of the prior Japanese Patent Application No. 2008-199838, filed on Aug. 1, 2008, the entire contents of which are incorporated herein by reference.

### FIELD

The embodiments discussed herein are related to a sputtering apparatus that deposits a film made of a predetermined material on a surface of a substrate, a sputtering method performed by the sputtering apparatus, and a method of manufacturing a magnetic recording medium using the sputtering method.

### BACKGROUND

In the field of computers, a large amount of information is handled on a daily basis, and hard disk drives (HDDs) are used as an example of an information storage that records and reproduces such a large amount of information. An HDD has features of large storage capacity and fast access speed, and generally includes a disk-shaped magnetic recording medium and a magnetic head for recording information onto the magnetic recording medium.

The magnetic recording medium includes a recording layer that is a film made of a magnetic material onto which information is magnetically recorded. A representative example of deposition methods of depositing such a film is a sputtering method. The sputtering method is a deposition method in which: gas ions and the like are caused to collide with a target formed of a material of the film; and material particles scattered from the target due to the collision are deposited on a surface of a substrate.

Sputtering apparatuses for depositing films by means of the sputtering method are widely used. Of these, magnetron sputtering apparatuses have been receiving attention in particular. A magnetron sputtering apparatus applies a magnetic field near a target and then traps electrons near the target, thereby preventing a deposited film from being damaged by secondary electrons and the like generated at the time of sputtering (see, for example, Japanese Laid-open Patent Publications Nos. 61-235562 and 09-20979). In the magnetron sputtering apparatus, gas molecules are caused to collide with the thus trapped electrons and are consequently ionized, so that ions are generated intensively near the target.

In recent years, various films formed on a substrate of such a magnetic recording medium have been reduced in thickness, examples of the films being: a recording layer, which is a film made of a magnetic material and onto which information is magnetically recorded; a backing layer, which is a film made of a soft magnetic material and which serves as a flux path for the magnetic field from the head; and an intermediate layer, which is a film made of a non-magnetic material and which is formed between the two layers to magnetically separate the layers from each other while controlling the orientation of crystals in the recording layer. At the same time, the requirement to make the thicknesses of the films uniform has been increasingly strict.

In view of the circumstances, rotary magnetron sputtering apparatuses have been proposed. In a rotary magnetron sputtering apparatus, a uniform magnetic field is generated near the target to generate ions uniformly near the target and to thereby improve the uniformity of the films at the time of deposition.

FIG. 29 illustrates an example of the rotary magnetron sputtering apparatus.

A rotary magnetron sputtering apparatus 500 illustrated in FIG. 29 includes a first chamber 510 and a second chamber 520 separated from the first chamber 510 by a side wall 501 which allows transmission of magnetic lines of force. In the first chamber 510, a disk substrate 600 is placed and a film is then deposited on the disk substrate 600. The first chamber 510 includes therein a substrate holding section 511 that holds the disk substrate 600. In the first chamber 510, a target 530, which is a plate made of a material of a film, is disposed in a position facing a deposition surface of the disk substrate 600 held by the substrate holding section 511. The second chamber 520 includes therein multiple magnets 541 and a rotary magnetron cathode (RMC) 540. The RMC 540 applies a magnetic field which has an arch shape having its vertex reaching a disk substrate 600 side of the target 530 and which rotates along the target 530, by rotating the magnets 541 about a rotation axis perpendicular to the target 530. The rotation of the magnetic field by the RMC 540 renders the rotation-direction magnetic field intensity uniform near the disk substrate 600 side of the target 530. Furthermore, the rotary magnetron sputtering apparatus 500 also includes a voltage source 550 that applies, to the target 530, negative voltage with respect to the first and second chambers 510 and 520 in a grounded state.

FIG. 30 schematically illustrates a state in which magnetic field intensity near the target is uniform in the rotary magnetron sputtering apparatus in FIG. 29.

FIG. 30 illustrates a schematic graph of a magnetic field intensity distribution in a measurement plane near the disk substrate 600 side of the target 530 and parallel to the surface of the target 530 in the rotary magnetron sputtering apparatus 500 in FIG. 29. In a graph G51 in FIG. 30, along the horizontal axis, plotted is the magnetic field intensity distribution on the circumference connecting four points A, B, C and D having a predetermined distance from the rotation axis of the RMC 540 on the measurement plane and being in circumferential-direction angular positions shifted “90°” with respect to each other. As depicted in the graph G51 in FIG. 30, by the rotation of the RMC 540, the magnetic field intensity is rendered uniform on the measurement plane in the circumferential direction, and therefore is rendered uniform in the rotation direction of the magnets 541 of the RMC 540.

In the rotary magnetron sputtering apparatus 500 illustrated in FIG. 29, electrons are trapped by the uniform magnetic field near the disk substrate 600 side of the target 530.

Here, the first chamber 510 is provided with a gas supply port 512 above, and a gas discharge port 513 below, the disk substrate 600 and the target 530 in a vertical direction in FIG. 29. At the time of deposition, the first chamber 510 is filled with a gas atmosphere. Then, gas molecules collide with electrons thus trapped in the atmosphere, so that gas ions are generated.

At the time of deposition, the voltage source 550 applies, to the target 530, voltage having a polarity causing the ions to head for the target 530. Consequently, the ions rapidly head for the target 530 and then collide with the target 530. Thereby, material particles are scattered from the target 530 due to the impact of the collision, and the scattered particles are deposited on the disk substrate 600. Thus, a film made of the material forming the target 530 is deposited on the disk substrate 600.

In the rotary magnetron sputtering apparatus 500, electrons which are a factor of the ion generation are trapped by a magnetic field having a uniform intensity distribution near the target 530. As a result, uniform ion density and also uniform sputtering distribution of the material particles from the target 530 are obtained, so that a film having a highly uniform film thickness is deposited on the disk substrate 600.

However, even the rotary magnetron sputtering apparatus 500 has a problem that the film thickness in the circumferential direction of the magnets 541 on the RMC 540 is not completely uniform. This problem has been considered as important with the recently-increasing requirement to further reduce film thickness. For this reason, film thickness has been desired to be even more uniform.

Given that the magnetic field intensity is rendered sufficiently uniform in the rotary magnetron sputtering apparatus 500, one possible factor of such non-uniform film thickness, although not definitely confirmed, is that the ion density in the first chamber 510 is not uniform due to non-uniform gas pressure or the like, so that the material particles are scattered from the target 530 unevenly in terms of a scattered amount. If the non-uniform gas pressure is the factor, conceivable countermeasures are to correct the relative arrangement of the gas supply port 512 and the gas discharge port 513 as well as a gas supply amount and a gas discharge amount, to correct the non-uniform gas pressure. However, such corrections require a lot of cost and time, and are thus difficult to make in many cases.

### SUMMARY

According to a basic aspect of the invention, a sputtering apparatus including:

a substrate holding section that holds a substrate on a surface of which a film is to be formed;

a target in a plate shape that is made of a material of the film and that is disposed in a position facing the surface of the substrate in an atmosphere of a predetermined gas;

a magnetic field generator that is disposed on a side, opposed to the substrate side, of the target, that generates a magnetic field having an arc shape with a vertex reaching the substrate side, and that rotates the magnetic field along the target;

a power source that applies, to the target, voltage of a polarity causing ions of the predetermined gas to head for the target; and

a magnetic plate that is inserted between the target and the magnetic field generator and that limits the magnetic field reaching the target at a part of a rotation path of the magnetic field.

The basic aspect of the sputtering apparatus includes the magnetic field generator that rotates the magnetic field along the target, and accordingly corresponds to the rotary magnetron sputtering apparatus. With the basic aspect of the sputtering apparatus, the circumferential-direction magnetic field intensity distribution, which is rendered uniform by rotation of the magnetic field near the target can be intentionally ruined by the magnetic plate. Thereby, when a film having a non-uniform thickness is deposited due to a factor such as non-uniform gas pressure in the sputtering apparatus as described above, the film thickness distribution at the time of next deposition can be adjusted by weakening the magnetic field intensity of a part in which the film is considered to have a large thickness by using the magnetic plate, to reduce the deposition amount of the material in the part. Thus, according to the basic aspect of the sputtering apparatus, deposition of a film having a uniform thickness is possible by a simple method of weakening the magnetic field intensity of a part in which the film is considered to have a large thickness, by using the magnetic plate, at the time of deposition. In addition, according to the basic aspect of the sputtering apparatus, the magnetic field of a part in which a film having a large thickness is formed in an actual result may be weakened in the next deposition. Consequently, whatever the cause of non-uniform thickness of a film, the non-uniformity can be resolved.

According to a basic aspect of the invention, a sputtering method performed in a sputtering apparatus including: a substrate holding section that holds a substrate on a surface of which a film is to be formed; a target in a plate shape that is made of a material of the film and that is disposed in a position facing the surface of the substrate in an atmosphere of a predetermined gas; a magnetic field generator that is disposed on a side, opposed to the substrate side, of the target, that generates a magnetic field having an arc shape with a vertex reaching the substrate side, and that rotates the magnetic field along the target; and a power source that applies, to the target, voltage of a polarity causing ions of the predetermined gas to head for the target, the method including:

disposing a magnetic plate between the target and the magnetic field generator in a position facing a region on the substrate where a film would have a relatively large thickness, the magnetic plate limiting the magnetic field reaching the target at a part of a rotation path of the magnetic field; and

applying the voltage to the target by the power source to cause the ions of the predetermined gas to head for the target.

According to the basic aspect of the sputtering method, in the sputtering apparatus, the magnetic plate is disposed in a position corresponding to a part, in which a film is considered to have a large thickness in practice, on the substrate, to weaken the magnetic field and reduce the deposition amount of the material in the part. Thus, deposition of a film having a uniform thickness is possible.

According to a basic aspect of the invention, a magnetic recording medium manufacturing method of depositing a magnetic film on a substrate held by a substrate holding section, the method including:

disposing a magnetic plate between a target in a plate shape and a magnetic field generator in a position facing a region on the substrate where a film would have a relatively large thickness, the target being made of a material of the magnetic film and being disposed in a position facing a surface of the substrate in an atmosphere of a predetermined gas, the magnetic field generator being disposed on a side, opposed to the substrate side, of the target; and

depositing the magnetic film on the substrate by sputtering in such a manner that a magnetic field having an arch shape reaching the substrate side of the target is generated by the magnetic field generator and that ions are caused to head for the target by applying, to the target, voltage of a polarity causing the ions of the predetermined gas to head for the target while rotating the magnetic field along the target, wherein

the magnetic plate limits the magnetic field reaching the target at a part of a rotation path of the magnetic field.

According to the basic aspect of the method of manufacturing a magnetic recording medium, a magnetic recording medium formed of a magnetic film having a uniform thickness can easily be obtained by sputtering using the sputtering method by which a magnetic film having a uniform thickness can be easily deposited.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a HDD;

FIG. 2 illustrates a rotary magnetron sputtering apparatus which is an example of a sputtering apparatus having the basic aspect;

FIG. 3 is a graph schematically illustrating a state in which a magnetic field is weakened on the upper side near a target by a soft magnetic plate;

FIG. 4 is a graph schematically illustrating a situation in which the material particle deposition amount on the upper part of the disk substrate is reduced by the soft magnetic plate, so that a uniform film thickness distribution is obtained;

FIG. 5 is a flowchart representing a flow of a process of the method of manufacturing a magnetron disk by using a sputtering method using the rotary magnetron sputtering apparatus in FIG. 2;

FIG. 6 illustrates an attachment structure of the target and the soft magnetic plate in FIG. 2 to the side wall;

FIG. 7 illustrates a procedure for attaching the target and the soft magnetic plate to the side wall of the first chamber in step S110 in the flowchart of FIG. 5;

FIG. 8 illustrates the three soft magnetic plates used in the experiment;

FIG. 9 illustrates the five kinds of experimental structures;

FIG. 10 illustrates the 20 measurement points near the target;

FIG. 11 is a graph plotting the magnetic field intensities at the 10 measurement points aligned on the circumference having a distance of “30 mm” from the disk center in each experimental structure;

FIG. 12 is a graph plotting the magnetic field intensities at the 10 measurement points aligned on the circumference having a distance of “60 mm” from the disk center in each experimental structure;

FIG. 13 is an explanatory view for explaining the film thickness measurement points;

FIG. 14 is a graph depicting the film thickness distribution in the first structure with no soft magnetic plate;

FIG. 15 is a graph depicting the film thickness distribution in the second structure with one small soft magnetic plate;

FIG. 16 is a graph depicting the film thickness distribution in the third structure with one medium soft magnetic plate;

FIG. 17 is a graph depicting the film thickness distribution in the fourth structure with one large soft magnetic plate;

FIG. 18 is a graph depicting the film thickness distribution in the fifth structure with three stacked medium soft magnetic plates;

FIG. 19 is a graph plotting the film thickness change amounts of each of the second and third experimental structures with respect to the first structure with no soft magnetic plate;

FIG. 20 is a graph plotting the uniform film thickness distribution obtained in the five kinds of experimental structures;

FIG. 21 is a schematic view illustrating a structure for improving the attachment stability of the soft magnetic plate 360;

FIG. 22 is a schematic view illustrating an example of a soft magnetic plate having a thickness becoming increasingly large toward the supply port;

FIG. 23 is a schematic view illustrating a state in which a semicircular soft magnetic plate is divided into two to obtain the medium and the smallest soft magnetic plates illustrated in FIG. 22;

FIG. 24 is a graph depicting the intensity distribution in the inner part when the magnetic field is weakened by using the arc-shaped soft magnetic plates;

FIG. 25 is a graph depicting the intensity distribution in the outer part when the magnetic field is weakened by using the arc-shaped soft magnetic plates;

FIG. 26 illustrates a state in which multiple kinds of soft magnetic plates having different effects of weakening the magnetic field are disposed on a single plane;

FIG. 27 is a graph depicting magnetic field intensity distribution obtained by the arrangement of the three kinds of soft magnetic plates illustrated in FIG. 26;

FIG. 28 illustrates the shape of the target which enables deposition of a film having a uniform thickness;

FIG. 29 illustrates an example of the rotary magnetron sputtering apparatus; and

FIG. 30 schematically illustrates a state in which magnetic field intensity near the target is uniform in the rotary magnetron sputtering apparatus in FIG. 29.

### DESCRIPTION OF EMBODIMENT

A concrete embodiment of a sputtering apparatus, a sputtering method and a method of manufacturing a magnetic recording medium, which have the above basic aspect will be described below with reference to the accompanying drawings.

Prior to the description of the embodiment of the sputtering apparatus, the sputtering method and the method of manufacturing a magnetic recording medium, a hard disk drive (HDD) including a magnetic disk created by the embodiment will be described first.

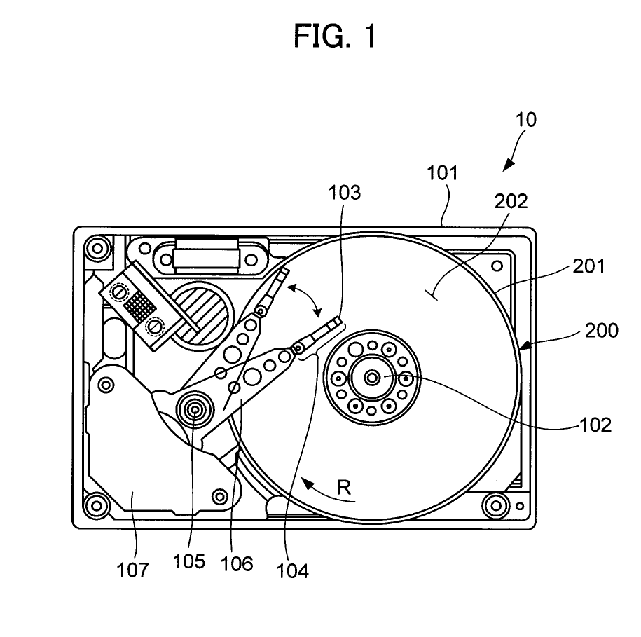

FIG. 1 illustrates a HDD.

A housing 10 of a HDD 10 illustrated in FIG. 1 houses a magnetic disk 200, a head gimbal assembly 104, a carriage arm 106 and an arm actuator 107. The magnetic disk 200 is created by the embodiment to be described later of the sputtering apparatus, the sputtering method and the method of manufacturing a magnetic recording medium which has been described in the above basic aspect, and is attached to a rotation shaft 102 and thereby rotates. The head gimbal assembly 104 having, at one end, a magnetic head 103 which records information onto and reproduces information from the magnetic disk 200. The head gimbal assembly 104 is fixed to the carriage arm 106, and the carriage arm 106 moves parallel to a surface of the magnetic disk 200 while rotating about an arm shaft 105. The actuator 107 drives the carriage arm 106.

The magnetic disk 200 is formed of a multilayered film 202 deposited on a disk substrate 201 made of a non-magnetic material. The multilayered film 202 includes, for example: a recording layer, which is made of a magnetic material and onto which information is magnetically recorded; a backing layer, which is made of a soft magnetic material and which serves as a flux path for the magnetic field from the magnetic head 103; and an intermediate layer, which is made of a non-magnetic material and which is formed between the recording layer and the backing layer to magnetically separate the layers from each other while controlling the orientation of crystals in the recording layer. The disk substrate 201 corresponds to an example of the substrate in the basic aspect, and each of the multiple layers forming the multilayered film 202 corresponds to an example of the film in the basic aspect.

To record information onto the magnetic disk 200 and reproduce information recorded on the magnetic disk 200, the carriage arm 106 is driven by the arm actuator 107, and the magnetic head 103 is thereby positioned above a desired track on the rotating magnetic disk 200. Along with the rotation of the magnetic disk 200, the magnetic head 103 tracks each track of the magnetic disk 200 and thereby sequentially records multiple information pieces.

Next, a sputtering apparatus used to manufacture the magnetic disk 200 included in the HDD 10 will be described.

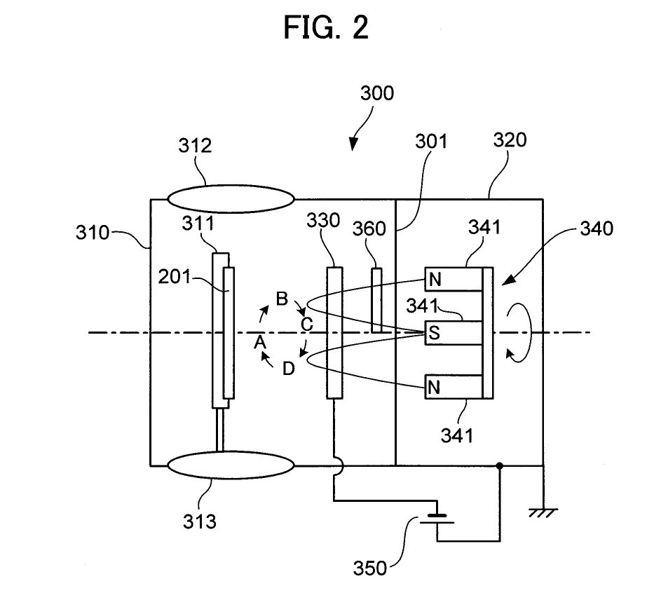

FIG. 2 illustrates a rotary magnetron sputtering apparatus which is an example of the sputtering apparatus having the basic aspect.

A rotary magnetron sputtering apparatus 300 illustrated in FIG. 2 includes therein: a first chamber 310 in which deposition is performed on the disk substrate 201 provided thereto; and a second chamber 320 divided from the first chamber 310 by a side wall 301 which transmits magnetic lines of force. The first chamber 310 includes therein: a substrate holding section 311 that holds the disk substrate 201; and a target 330 which is a plate made of a material of a film and which is disposed in a position facing a deposition surface of the disk substrate 201 held by the substrate holding section 311. The second chamber 320 includes therein multiple magnets 341 and a rotary magnetron cathode (RMC) 340. The RMC 340 applies a magnetic field which has an arch shape having its vertex reaching a disk substrate 201 side of the target 330 and which rotates along the target 330, by rotating the magnets 341 about a rotation axis perpendicular to the target 330. The rotation of the magnetic field by the RMC 340 renders the rotation-direction magnetic field intensity uniform near the disk substrate 201 side of the target 330. Furthermore, the rotary magnetron sputtering apparatus 300 also includes a voltage source 350 which applies, to the target 330, negative voltage with respect to the first and second chambers 310 and 320 in a grounded state.

The substrate holding section 311 corresponds to an example of the substrate holding section in the basic aspect; the target 330 corresponds to an example of the target in the basic aspect; the RMC 340 corresponds to an example of the magnetic field source in the basic aspect; the voltage source 350 corresponds to an example of the power source in the basic aspect.

Here, the rotary magnetron sputtering apparatus 300 of this embodiment includes a soft magnetic plate 360 made of a soft magnetic material and disposed between the target 330 and the side wall 301. The soft magnetic plate 360 reduces magnet fields to reach an upper part of the disc-like target 330, the upper part corresponding to a part of a rotation path of the magnetic field from the RMC 340, in FIG. 2. In the rotary magnetron sputtering apparatus 300, magnetic field intensity near a disk substrate 201 side of the target 330 is weakened around the upper part of target 330 in FIG. 2 due to the soft magnetic plate 360, and is thus non-uniform in a rotation direction of the rotation. The soft magnetic plate 360 corresponds to an example of the magnetic plate in the basic aspect.

In this embodiment, by using the soft magnetic plate 360 capable of transmitting a magnetic field to some extent, the magnetic field intensity can be weakened appropriately and not too much.

This indicates that an applied aspect that “the magnetic plate is made of a soft magnetic material” is preferable to the basic aspect.

The soft magnetic plate 360 of this embodiment also corresponds to an example of the magnetic plate in the applied aspect.

In the rotary magnetron sputtering apparatus 300, electrons are trapped near the disk substrate 201 side of the target 330 by the magnetic field applied by the RMC 340.

Here, the first chamber 310 is provided with a gas supply port 312 above, and a gas discharge port 313 below, the disk substrate 201 and the target 330 in a vertical direction in FIG. 2. At the time of deposition on the disk substrate 201, Ar gas is supplied from the supply port 312 and is then discharged from the discharge port 313, so that the Ar gas flows in the first chamber 310 from the upper side to the lower side in FIG. 2. When Ar molecules collide with the electrons trapped near the disk substrate 201 side of the target 330 by the magnetic field, in the Ar gas atmosphere, ionization occurs and positive Ar ions are generated consequently.

During the generation of ions, negative voltage is applied to the target 330 by the voltage source 350. Accordingly, the Ar ions head for and then collide with the target 330. Material particles forming the target 330 are scattered by the impact of the collision, and are then deposited on the disk substrate 201. Thus, a film made of the material is deposited.

As will be described later, if deposition is performed without providing the soft magnetic plate 360 to the rotary magnetron sputtering apparatus 300 of this embodiment, a non-uniform film which is thick on the upper side in FIG. 2 is formed. One possible factor of such non-uniform film thickness is as follows, although not definitely confirmed. Since the Ar gas flows from the upper side to the lower side with respect to the disk substrate 201, the gas pressure is higher on the upper side than the lower side. As a result, on the upper side near the target 330, the Ar ion amount on the upper side near the target 330 is relatively larger, and consequently the scattered material particle amount is also larger. Accordingly, the material particle deposition amount on the disk substrate 201 is larger on the upper side.

This indicates that an applied aspect that “the sputtering apparatus further includes a chamber that includes: a main body in an inside of which the substrate holding section and the target are housed, and the inside of which is filled with the atmosphere of the predetermined gas; and a supply port from which the predetermined gas is supplied to the inside of the main body, wherein the magnetic plate limits the magnetic field reaching the target at a part of the rotation path of the magnetic field on the supply port side” is preferable to the basic aspect.

With this applied aspect, a situation in which the non-uniform film thickness is attributable to the non-uniform gas pressure as described above can be appropriately handled.

In this embodiment, the magnetic field intensity on the upper side near the target 330 is weakened by the soft magnetic plate 360 disposed so as to block a part of the rotation path of the magnetic field, the part being on the supply port 312 side.

The first chamber 310 of this embodiment corresponds to an example of the chamber in the applied aspect, and the supply port 312 corresponds to an example of the supply port in the applied aspect. The soft magnetic plate 360 of this embodiment corresponds also to an example of the magnetic plate in the applied aspect.

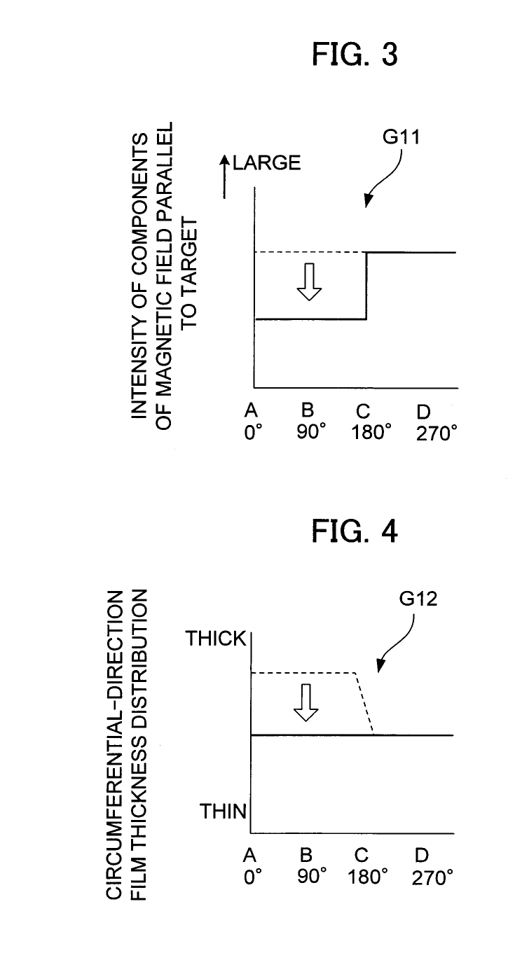

FIG. 3 is a graph schematically illustrating a state in which a magnetic field is weakened on the upper side near the target 330 by the soft magnetic plate 360.

FIG. 3 schematically illustrates, in a graph form, a magnetic field intensity distribution near the disk substrate 201 side of the target 330 and within a measurement plane parallel to the surface of the target 330 in the rotary magnetron sputtering apparatus 300 in FIG. 2. In a graph G11 in FIG. 3, the horizontal axis depicts the magnetic field intensity distribution on the circumference connecting four points A, B, C and D having a predetermined distance from the rotation axis of the RMC 340 on the measurement plane and having circumferential-direction angular positions shifted “90°” with respect to each other. As depicted in the graph G11 in FIG. 3, the intensity, of the magnetic field from the RMC 340, on the circumference on the measurement plane is weakened on the upper side, i.e., in a region between the angular positions of “0°” and “180°.”

Consequently, generation of Ar ions is suppressed on the upper side near the target 330, the scattered material particle amount from the target 330 is reduced on the upper side, and the material particle deposition amount on the upper part of the disk substrate 201 is reduced. Thus, the increase of the film thickness of the upper part is prevented, so that uniform film thickness distribution can be obtained.

FIG. 4 is a graph schematically illustrating a situation in which the material particle deposition amount on the upper part of the disk substrate is reduced by the soft magnetic plate 360, so that a uniform film thickness distribution is obtained.

In a graph G12 in FIG. 4, the horizontal axis depicts the magnetic field intensity distribution on the circumference connecting four points A, B, C and D having a predetermined distance from the rotation axis of the RMC 340 on the disk substrate 201 on which deposition has been performed, and having circumferential-direction angular positions shifted “90°” with respect to each other. As depicted in the graph G12 in FIG. 4, in this embodiment, the magnetic field is weakened on the upper side near the target 330 by the soft magnetic plate 360, and therefore an increase in the film thickness of the upper part of the disk substrate 201 is suppressed, so that uniform film thickness distribution is obtained.

Next, a method of manufacturing a magnetic disk by means of a sputtering method using the rotary magnetron sputtering apparatus 300 according to this embodiment will be described.

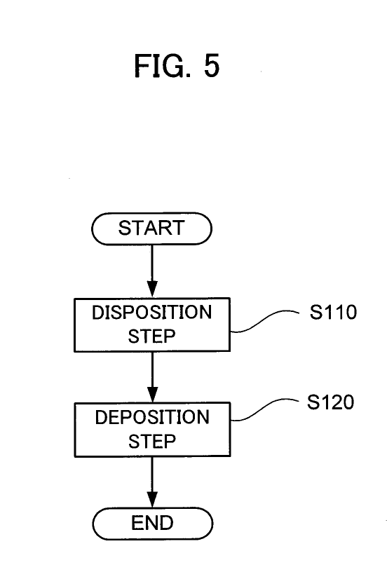

FIG. 5 is a flowchart representing a flow of a process of the method of manufacturing a magnetic disk by using a sputtering method using the rotary magnetron sputtering apparatus 300 in FIG. 2.

The process represented in the flowchart in FIG. 5 corresponds to an example of a combination of the sputtering method and the method of manufacturing a magnetic recording medium in the basic aspect.

In the flowchart in FIG. 5, first, the disk substrate 201 onto which a magnetic film is to be deposited is held by the substrate holding section 311 at a predetermined position in the first chamber 310 of the rotary magnetron sputtering apparatus 300 in FIG. 2 so that the deposition surface of the disk substrate 201 would face the side wall 301, and the target 330 and the soft magnetic plate 360 are then disposed in the first chamber 310 in the following manner (step S110). Here, step S110 corresponds to a combination of the disposition step in the basic aspect of the sputtering method and the step of “disposing a magnetic plate” in the basic aspect of the method of manufacturing a magnetic recording medium.

In this embodiment, the target 330 and the soft magnetic plate 360 are attached to a wall surface of the side wall 301, the wall surface being on a first chamber 310 side, although this state is only schematically illustrated in FIG. 2. Thereby, the deposition surface of the disk substrate 201 faces a surface of the target 330.

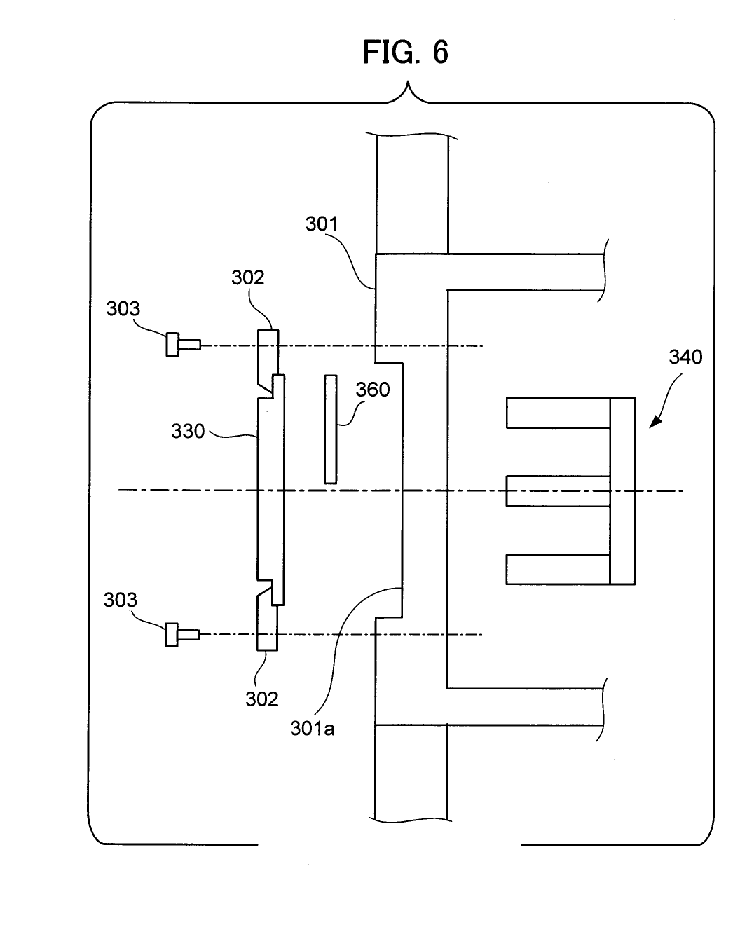

FIG. 6 illustrates an attachment structure of the target 330 and the soft magnetic plate 360 in FIG. 2 to the side wall.

As illustrated in FIG. 6, in this embodiment, a recess 301a into which the target 330 and the soft magnet plate 360 are to be fitted is formed in the wall surface of the side wall 301 on the first chamber 310 side. The RMC 340 in the second chamber 320 is disposed in such a position that the RMC 340 can apply a magnetic field toward the recess 301a.

In this embodiment, the following attachment structure is employed. Specifically, after the soft magnetic plate 360 is placed in the recess 301a, the target 330 is fitted into the recess 301a. The rim of the target 330 is fixed by a retaining member 302 and screws 303 fastening the retaining member 302 to the side wall 301. Thereby, the soft magnetic plate 360 and the target 330 are fixed to the side wall 301.

This indicates that an applied aspect that “the sputtering apparatus further includes a magnetic plate holding section that detachably holds the magnetic plate” is preferable to the basic aspect.

With this applied aspect, operation such as replacing the magnetic plate with another appropriate magnetic plate or the like can be possible depending on a degree of non-uniformity of the film in thickness on the substrate at the time of deposition.

In this embodiment, although being fixed by the attachment structure illustrated in FIG. 6, the soft magnetic plate 360 can be removed when necessary by removing the retaining member 302. The attachment structure of this embodiment corresponds to an example of the magnetic plate holding section in the applied aspect.

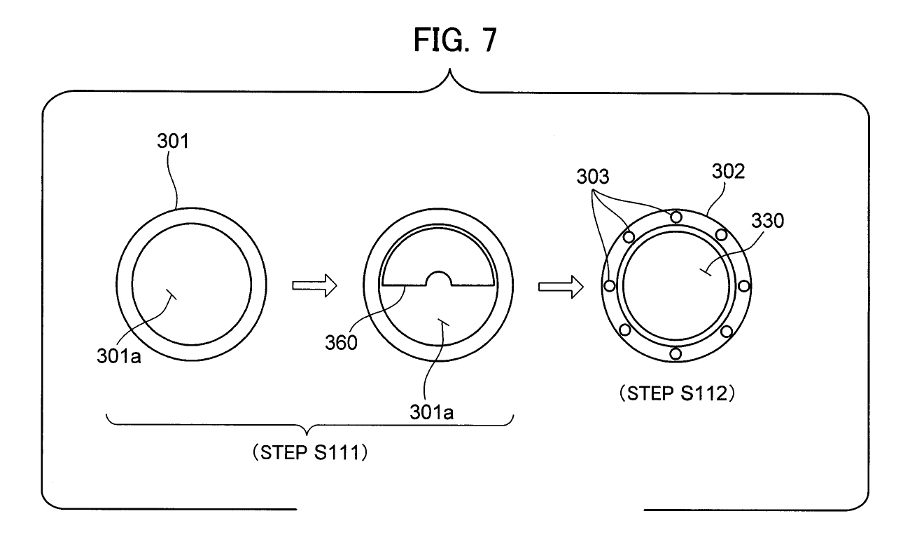

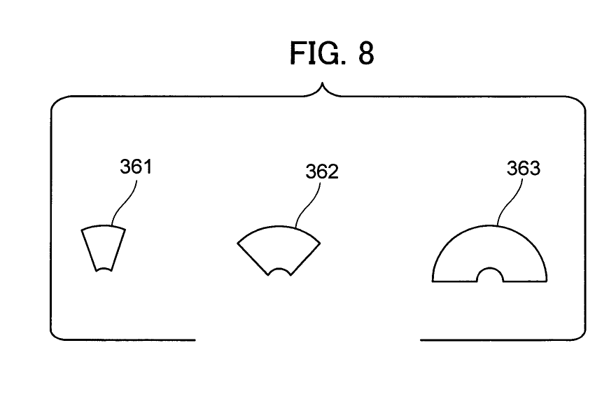

FIG. 7 illustrates a procedure for attaching the target 330 and the soft magnetic plate 360 to the side wall of the first chamber 310 in step S110 in the flowchart of FIG. 5.

As illustrated in FIG. 7, first, the soft magnetic plate 360 is placed in an upper part of the recess 301a in the side wall 301 in FIG. 7 (step S111). Then, the target 330 is fitted into the recess 301a, the retaining member 302 also illustrated in FIG. 6 is placed over the target 330, and the retaining member 302 is fastened to the side wall 301 by the multiple screws 303 (step S112). Thus, the soft magnetic plate 360 and the target 330 are fixed to the side wall 301 in such a manner that the soft magnetic plate 360 is pressed against a bottom of the recess 301a by the target 330.

As described above, when the disk substrate 201, the target 330 and the soft magnetic plate 360 are disposed in the first chamber 310 illustrated in FIG. 2 in step S110 in the flowchart of FIG. 5, Ar gas is started to be supplied from the supply port 312 to the first chamber 310 and then discharged from the discharge port 313; then, the RMC 340 starts to rotate, and the voltage source 350 starts to apply voltage to the target 330 (step S120). In step S120, Ar ions are generated near the target 330, the Ar ions collide with the target 330, and material particles scattered by the collision are deposited on the deposition surface of the disk substrate 201. Thus, a magnetic film is formed. Here, step S120 corresponds to an example of the voltage application step in the basic aspect of the sputtering method and the step of “depositing a magnetic layer” in the basic aspect of the method of manufacturing a magnetic recording medium.

In this embodiment, in step S120, the magnetic field on the upper side of FIG. 2 near the target 330 is weakened by the soft magnetic plate 360 as described above. Thereby, excessive deposition of material particles on the upper part of the disk substrate 201 due to non-uniform Ar gas pressure, for example, is suppressed, so that a magnetic film having a uniform film thickness is formed. Moreover, in this embodiment, such a film having a uniform thickness can be deposited by means of the simple method of weakening the magnetic field of a part considered to have a large thickness, by the soft magnetic plate 360. Hence, with the rotary magnetron sputtering apparatus 300 and the sputtering method using the rotary magnetron sputtering apparatus 300 according to this embodiment, a film having a uniform thickness can easily be deposited.

In this embodiment, a check is made in advance on how a film thickness is non-uniform when deposition is performed in a state where the magnetic field near the target 330 is uniform in the rotary magnetron sputtering apparatus 300. Furthermore, the size and the position of a soft magnetic plate 360 which is optimum for rendering such a non-uniform film thickness uniform are determined.

Next, an experiment carried out by the inventors of the present invention in order to determine the optimum soft magnetic plate 360 in the rotary magnetron sputtering apparatus 300 will be described.

In the experiment, the following three kinds of soft magnetic plates are used.

FIG. 8 illustrates the three soft magnetic plates used in the experiment.

In FIG. 8, three kinds of soft magnetic plates, small, medium and large soft magnetic plates 361, 362 and 363, are illustrated. The soft magnetic plates 361, 362 and 363 are fan-shaped plates having a thickness of “0.3 mm,” and are different in fan-shaped area from each other. The area of the small soft magnetic plate 361 is “12566 mm²;” the area of the medium soft magnetic plate 362 is “25132 mm²;” the area of the large soft magnetic plate 363 having a semicircular shape is “50265 mm².” The soft magnetic plates are formed of Fe having magnetic permeability of “5000” and saturation magnetization of “2.15 T.”

By using the three kinds of soft magnetic plates 361, 362 and 363, the following five kinds of experimental structures are formed.

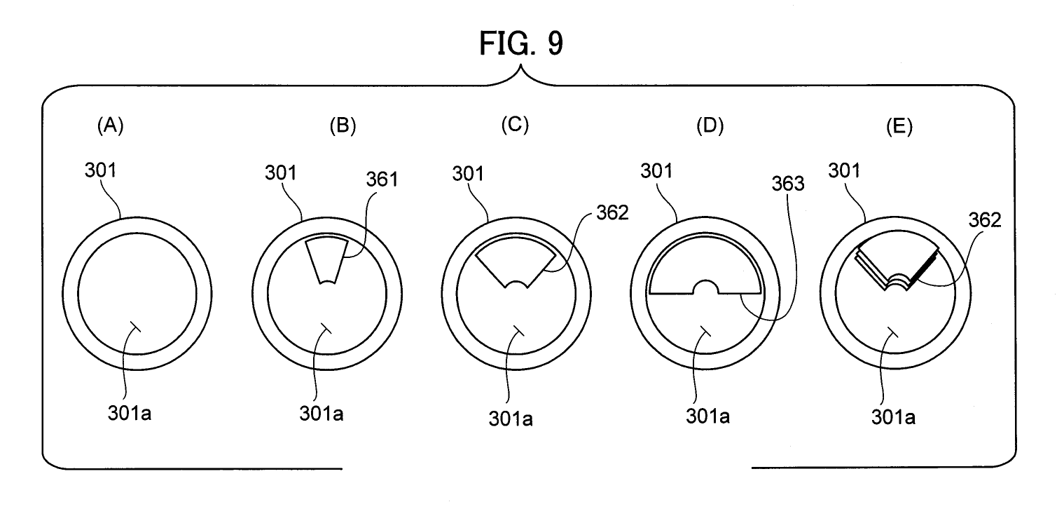

FIG. 9 illustrates the five kinds of experimental structures.

In this experiment, first to fifth structures respectively illustrated in parts (A) to (E) in FIG. 9 are formed: the first structure in which no soft magnetic plate is disposed in the recess 301a in the side wall 301; the second structure in which the small soft magnetic plate 361 is disposed in the recess 301a; the third structure in which the medium soft magnetic plate 362 is disposed in the recess 301a; the fourth structure in which the large soft magnetic plate 363 is disposed in the recess 301a; and the fifth structure in which the three stacked medium soft magnetic plates 362 are disposed in the recess 301a. Here, this experiment was performed after it had been demonstrated that, in deposition using no soft magnetic plate, the film thickness on the upper part of the disk substrate 201 increases as will be described later. Accordingly, the soft magnetic plates are disposed on the upper part of the recess 301a in the second to fifth experimental structures. In this experiment, as will be described later, deposition is performed in each experimental structure, and the film thickness distribution of the deposited film is measured.

In this experiment, prior to the film thickness distribution measurement, first, the magnetic intensity distribution near the target 330 illustrated in FIG. 2 in each experimental structure is measured, to check the influence of each soft magnetic plate disposition on uniformity destruction of the intensity of the magnetic field applied near the target 330 by the RMC 340.

Here, in the intensity distribution measurement, the magnetic field intensity is measured at each of the following 20 measurement points located on a measurement plane having a predetermined distance from a surface of the target 330, the surface being on the disk substrate 201 side.

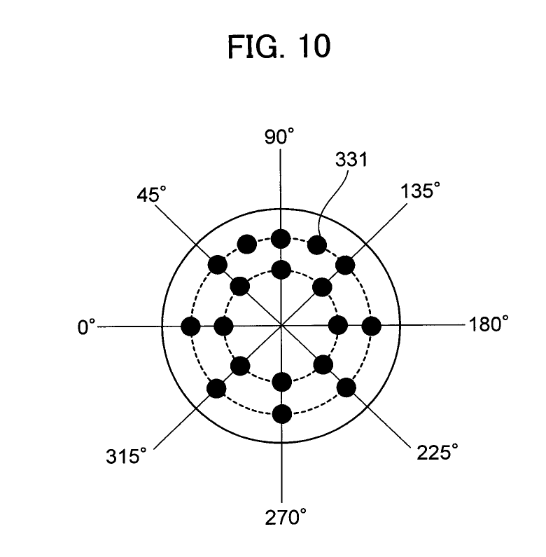

FIG. 10 illustrates the 20 measurement points near the target 330.

As illustrated in FIG. 10, measurement points 331 are located respectively at the following 10 kinds of circumferential-direction angular positions each having a distance of “30 mm” or “60 mm” from the disk center. The 10 kinds of circumferential-direction angular positions are “0°”, “45°”, “67.5°”, “90°”, “112.5°”, “135°”, “180°”, “225°”, “270°”, and “315°”.

Table 1 presents magnetic field intensity measurement results of the 20 measurement points 331.

TABLE 1

| | | Magnetic field intensity \sqrt{Bx² + By² + Bz²} | | | |
|---|---|---|---|---|---|
| | | [mT] | | | |
| | | | 1 medium | 1 large | 3 medium |
| Circumference- | | No soft | soft | soft | soft |
| direction angle | | magnetic | magnetic | magnetic | magnetic |
| [°] | | plate | plate | plate | plates |
| Radius | 0 | 91.1 | 90.2 | 81.1 | 88.5 |
| 30 mm | 45 | 91.1 | 82.6 | 79.7 | 71.5 |
| | 67.5 | 90.1 | 81.5 | 79.9 | 68.3 |
| | 90 | 88.5 | 79.5 | 79.5 | 67.2 |
| | 112.5 | 88.1 | 79.7 | 77.7 | 66.1 |
| | 135 | 87.3 | 80.5 | 77.9 | 68.4 |
| | 180 | 88.5 | 87.5 | 80.2 | 84.5 |
| | 225 | 90.2 | 88.9 | 88.2 | 87.6 |
| | 270 | 94.8 | 87.6 | 87.7 | 87.1 |
| | 315 | 92.6 | 92.4 | 91.1 | 89.8 |
| Radius | 0 | 56.5 | 57.0 | 49.7 | 54.0 |
| 60 mm | 45 | 63.6 | 54.9 | 50.9 | 44.0 |
| | 67.5 | 58.7 | 49.2 | 46.9 | 37.4 |
| | 90 | 55.1 | 45.8 | 47.1 | 33.3 |
| | 112.5 | 58.7 | 46.5 | 46.9 | 36.7 |
| | 135 | 66.3 | 56.8 | 54.8 | 40.4 |
| | 180 | 51.5 | 46.7 | 45.0 | 50.2 |
| | 225 | 61.2 | 60.1 | 60.8 | 61.2 |
| | 270 | 54.6 | 55.1 | 57.3 | 54.1 |
| | 315 | 60.8 | 60.3 | 59.5 | 59.7 |

Table 1 presents the magnetic field intensities of the 10 measurement points 331 aligned on the circumference having a distance of “30 mm” from the disk center and the 10 measurement points 331 aligned on the circumference having a distance of “60 mm” from the disk center, in the first structure with no soft magnetic plate, the third structure with the medium soft magnetic plate 362, the fourth structure with the large soft magnetic plate 363 and the fifth structure with the three stacked medium soft magnetic plates 362. Here, the measurement results of the second structure with the small soft magnetic plate 361 have little difference from those of the first structure, and are thus omitted in Table 1.

The measurement results will be described with reference to a graph depicting the results in such a manner that comparison can easily be made between the results of the different experimental structures.

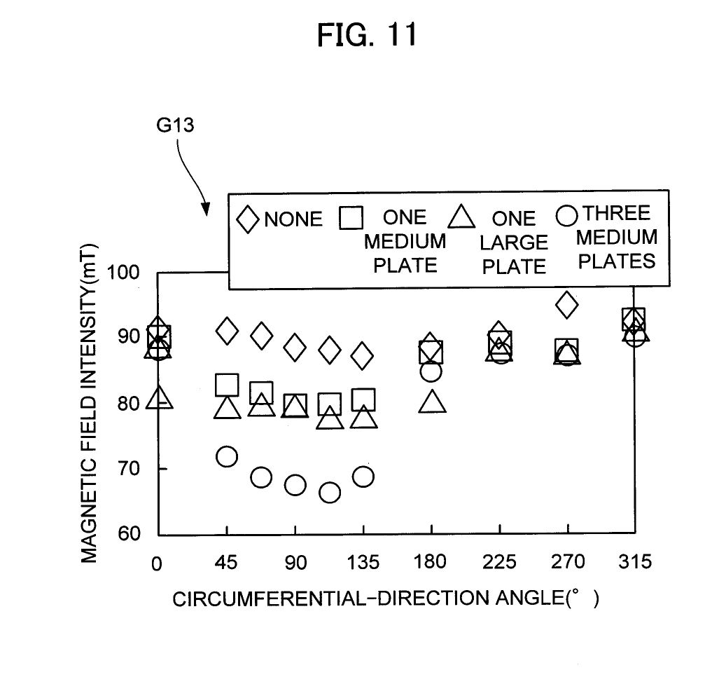

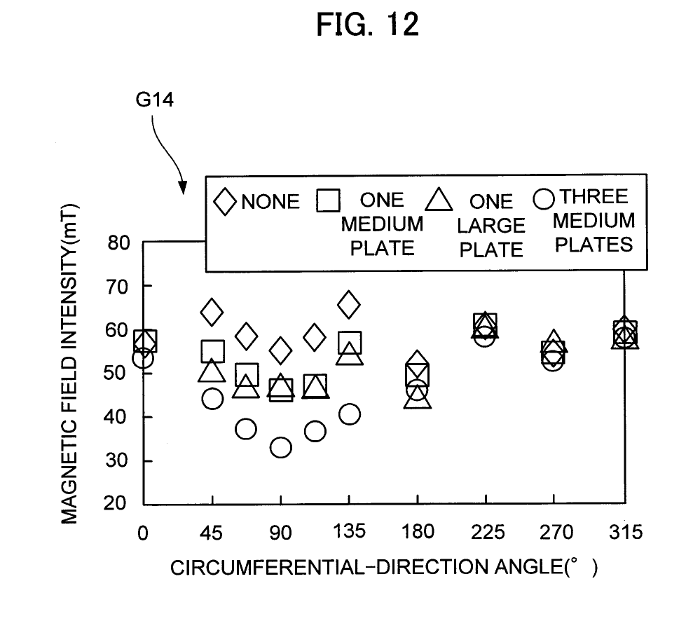

FIG. 11 is a graph plotting the magnetic field intensities at the 10 measurement points aligned on the circumference having a distance of “30 mm” from the disk center in each experimental structure; FIG. 12 is a graph plotting the magnetic field intensities at the 10 measurement points aligned on the circumference having a distance of “60 mm” from the disk center in each experimental structure.

In both a graph G3 in FIG. 11 and a graph G14 in FIG. 12, the measurement results of the first structure with no soft magnetic plate are plotted by diamonds, the measurement results of the third structure with the medium soft magnetic plate 362 are plotted by squares, the measurement results of the fourth structure with the large soft magnetic plate 363 are plotted by triangles, and the measurement results of the fifth structure with the three stacked medium soft magnetic plates 362 are plotted by circles.

As can be seen from the graphs G13 and G14, the magnetic intensity distribution is approximately uniform in the circumferential direction in the case of the first structure with no soft magnetic plate. In the case of each of the experimental structures with one or more soft magnetic plates, a decrease in the magnetic field intensity is partially found, and the range in which the decrease is found is larger as the fan-shaped area of the soft magnetic plate is larger. The comparison between the measurement results of the third structure and the fifth structure shows that the magnetic field intensity becomes smaller as the number of disposed soft magnetic plates is larger.

In this experiment, deposition is performed in each of the five kinds of experimental structures which ruin the uniformity of the magnet field intensity near the target 330 as described above, and the film thickness distribution of the deposited film is then measured.

Here, a chamber having a volume of “45 liters” is used as the first chamber 310, and a disk-shaped plate made of Cr and having a thickness of “6 mm” and a radius of “82 mm” is used as the target 330. Cr is a non-magnetic material and is not normally used for a recording layer of a magnetic recording medium. However, a Cr plate can easily transmit magnetic lines of force for the magnetic field from the RMC 340, making it possible to easily obtain a magnetic field having a uniform intensity distribution near the target 330. For this reason, the target made of Cr is used for verification. To form a magnetic film such as a recording layer in the rotary magnetron sputtering apparatus 300 by using a target made of a magnetic material such as Co alloy, a strong magnetic field is generated by the RMC 340, and a magnetic field having a uniform intensity distribution is applied near the target made of the magnetic material.

Here, the distance between the target 330 and the RMC 340 is “18.7 mm” and the distance between the target 330 and the disk substrate 201 is “32 mm.” Deposition is performed under apparatus conditions that supply power for voltage application to the target 330 is “400 W (63.6 W/mm²)”, deposition time is “30 sec”, the flow rate of Ar gas is “100 sccm (cc/min)”, and gas pressure is “0.67 Pa”.

Under these conditions, film thickness of the disk substrate 201 on which deposition has been performed is measured for each of the following multiple measurement points.

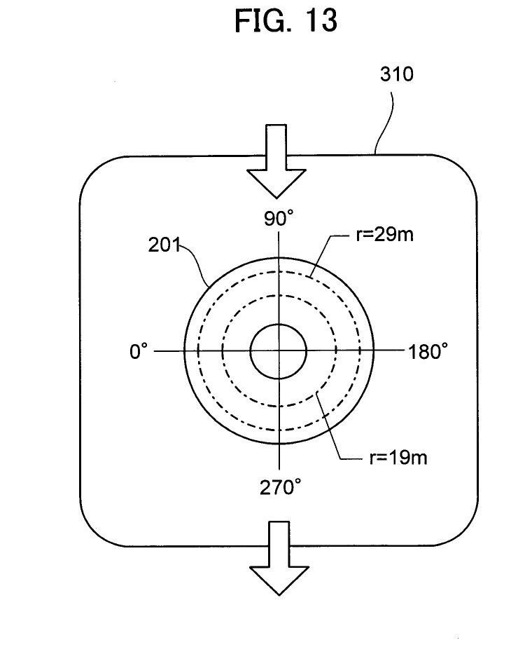

FIG. 13 is an explanatory view for explaining the film thickness measurement points.

In FIG. 13, the deposition surface of the disk substrate 201 in the rotary magnetron sputtering apparatus 300 illustrated in FIG. 2 is schematically illustrated.

Here, the Ar gas supply side, which is the upper side in FIG. 13, is assumed to be “90°”, and the Ar gas discharge side, which is the lower side in FIG. 13, is assumed to be “270°”. The film thickness is measured at two measurement points respectively having a distance of “19 mm” and “29 mm” from the disk center in each of eight circumferential-direction angular positions shifted “45°” with respect to each other. Thereafter, the mean value of the two film thicknesses obtained for each angular position and the mean value of the 16 film thicknesses obtained for all the 16 measurement points are calculated, and the ratio of the former value to the latter value is calculated. Then, by plotting the calculation results of the angular positions on a graph, the film thickness distribution in each experimental structure is obtained.

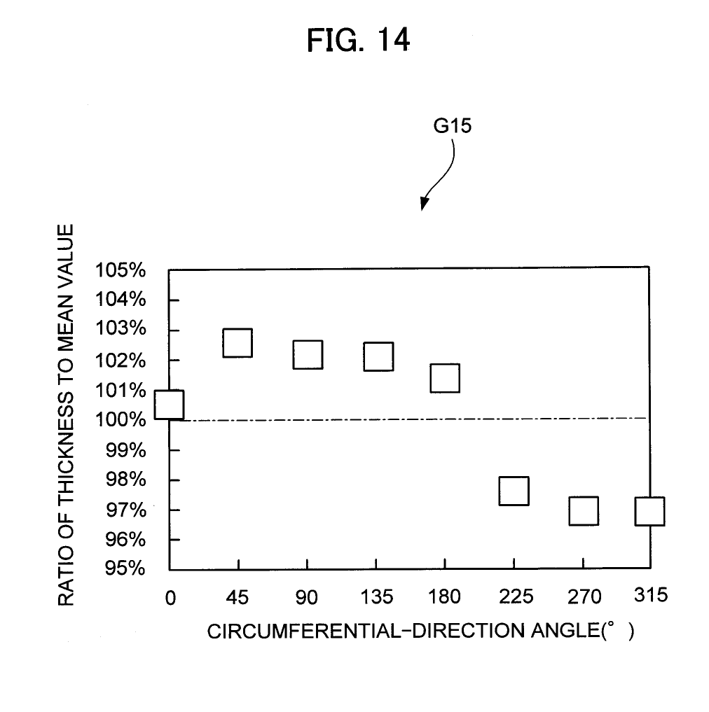

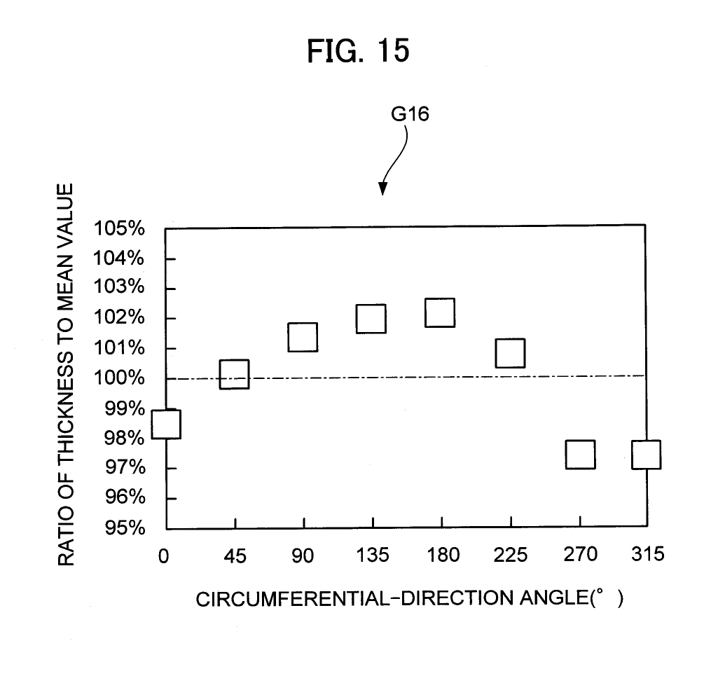

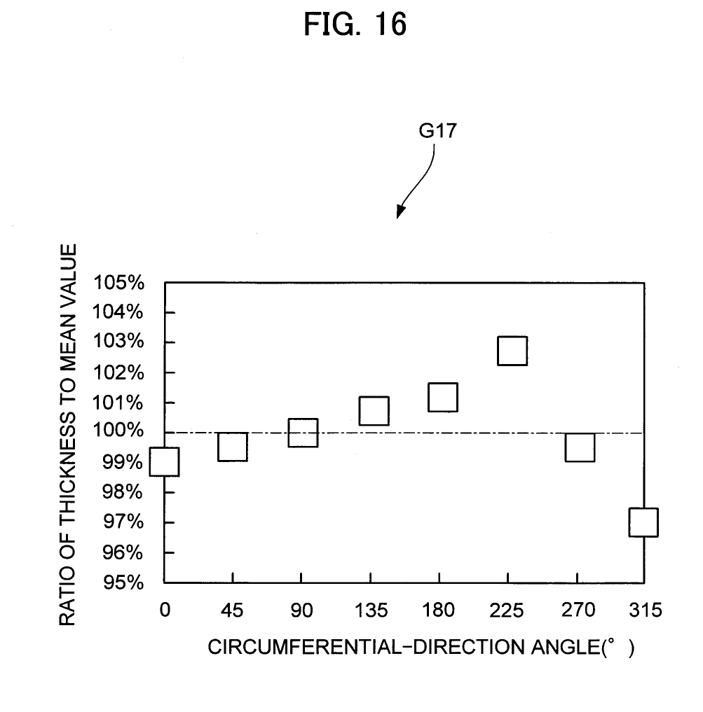

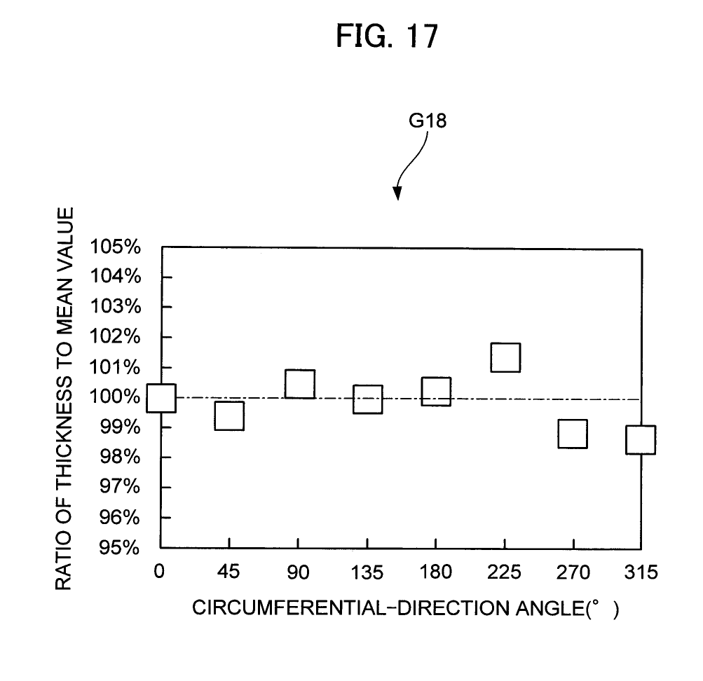

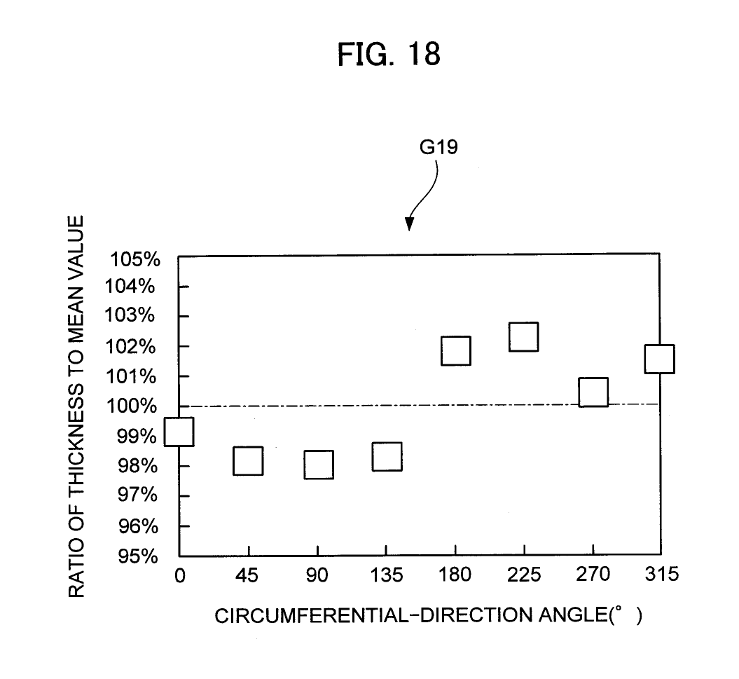

FIG. 14 is a graph depicting the film thickness distribution in the first structure with no soft magnetic plate; FIG. 15 is a graph depicting the film thickness distribution in the second structure with one small soft magnetic plate; FIG. 16 is a graph depicting the film thickness distribution in the third structure with one medium soft magnetic plate; FIG. 17 is a graph depicting the film thickness distribution in the fourth structure with one large soft magnetic plate; FIG. 18 is a graph depicting the film thickness distribution in the fifth structure with three stacked medium soft magnetic plates.

As can be seen from a graph G15 in FIG. 14, in the first structure with no soft magnetic plate, the film is thick in the range between the circumferential-direction angular positions “0°” and “180°”, that is, on the upper half of the disk substrate 201 in FIG. 2. By contrast, as can be seen from a graph G16 in FIG. 15, a graph G17 in FIG. 16, a graph G18 in FIG. 17 and a graph G19 in FIG. 18, the film thickness distributions change in such a manner that the film in the upper part is thinner when one or more soft magnetic plates are disposed. In the graph G19 in FIG. 18, which is a graph for the fifth structure with three stacked medium soft magnetic plates, the magnetic field is blocked to a large extent by the three soft magnetic plates, so that the upper part of the film becomes too thin. As a result, the upper part of the film ends up with being smaller than that on the lower side, resulting in non-uniform film thickness distribution.

Next, changes in film thickness at each measurement point depending on soft magnetic plate dispositions will be described.

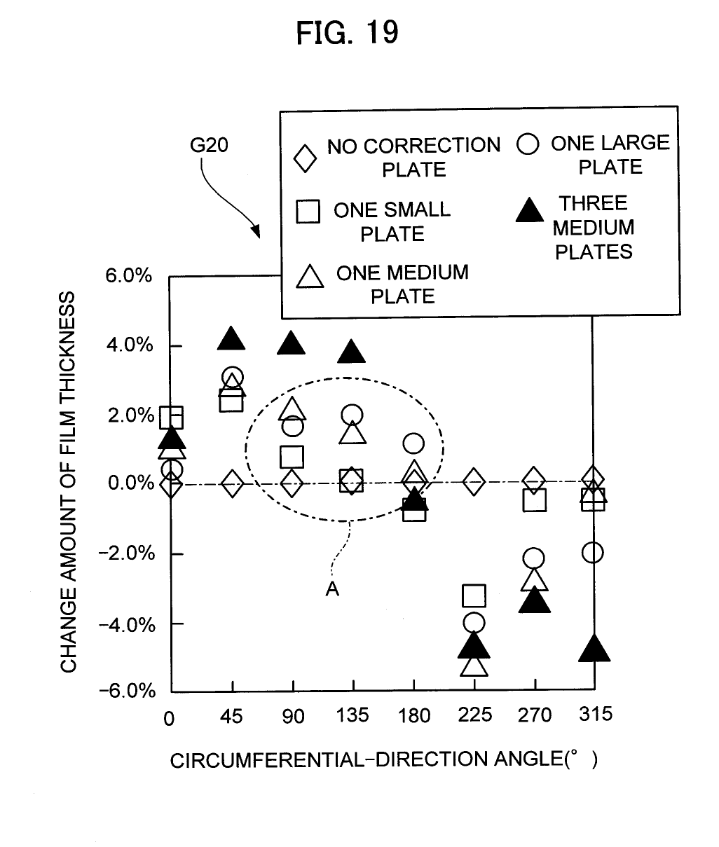

FIG. 19 is a graph plotting the film thickness change amounts of each of the second and third experimental structures with respect to the first structure with no soft magnetic plate.

In a graph G20 in FIG. 19, the horizontal axis depicts the circumferential-direction angular positions, and the vertical axis depicts the film thickness change amounts with respect to the film thickness of the first structure with no soft magnetic plate. In the graph G20, the film thickness change amounts of the first structure, which are the references, are all plotted by diamonds at “0%”, the film thickness change amounts of the second structure with one small soft magnetic plate are plotted by squares, the film thickness change amounts of the third structure with one medium soft magnetic plate are plotted by triangles, the film thickness change amounts of the fourth structure with one large soft magnetic plate are plotted by circles, and the film thickness change amounts of the fifth structure with three stacked medium soft magnetic plates are plotted by black triangles.

As can be seen from the graph G20 in FIG. 19, the range in which film thickness changes is larger as the fan-shaped area of the soft magnetic plate is larger, which is especially seen in a range A surrounded by a dotted line in the graph G20. From a comparison between the film thickness change amounts of the third structure plotted by the triangles and the film thickness change amounts of the fifth structure plotted by the black triangles, it is understood that, as the number of stacked soft magnetic plates is larger, the film thickness change amounts are also larger.

The experiment results indicate that an optimum soft magnetic plate can be determined by the following procedure. Specifically, first, experimental deposition is performed with no soft magnetic plate, and the film thickness measurement is performed, to obtain the position and the size of an area in which the film thickness is large. Then, as optimum soft magnetic plates, soft magnetic plates each having an area according to the size are prepared. Subsequently, by disposing one of the prepared soft magnetic plates and performing experimental deposition and film thickness measurement again, the uniformity of the film thickness is checked. If the check result does not show sufficient uniformity, the soft magnetic plates are disposed in a stacked manner, and the deposition and uniformity check are repeated. Thereby, in actual deposition, a required number of prepared optimum soft magnetic plates are disposed in a stacked manner, to perform deposition of a film having a uniform thickness. The optimum soft plate 360 in the rotary magnetron sputtering apparatus 300 of this embodiment illustrated in FIG. 2 is determined as follows.

As depicted in FIG. 14, in the rotary magnetron sputtering apparatus 300, the film appears to have a non-uniform thickness when no soft magnetic plate is used, the film having an increase in thickness in the range between the circumferential-directions “0°” and “180°”, i.e., the upper half. This indicates that the large soft magnetic plate 363 having a semicircular shape is suitable to be used as the soft magnetic plate. Moreover, as seen from FIG. 17, when only a single large soft magnetic plate 363 is disposed, sufficient uniformity is obtained. Furthermore, the following check based on deposition and measurement results of the five kinds of experimental structures also demonstrates that a film having a uniform thickness can be deposited when a single large soft magnetic plate 363 is disposed in the rotary magnetron sputtering apparatus 300.

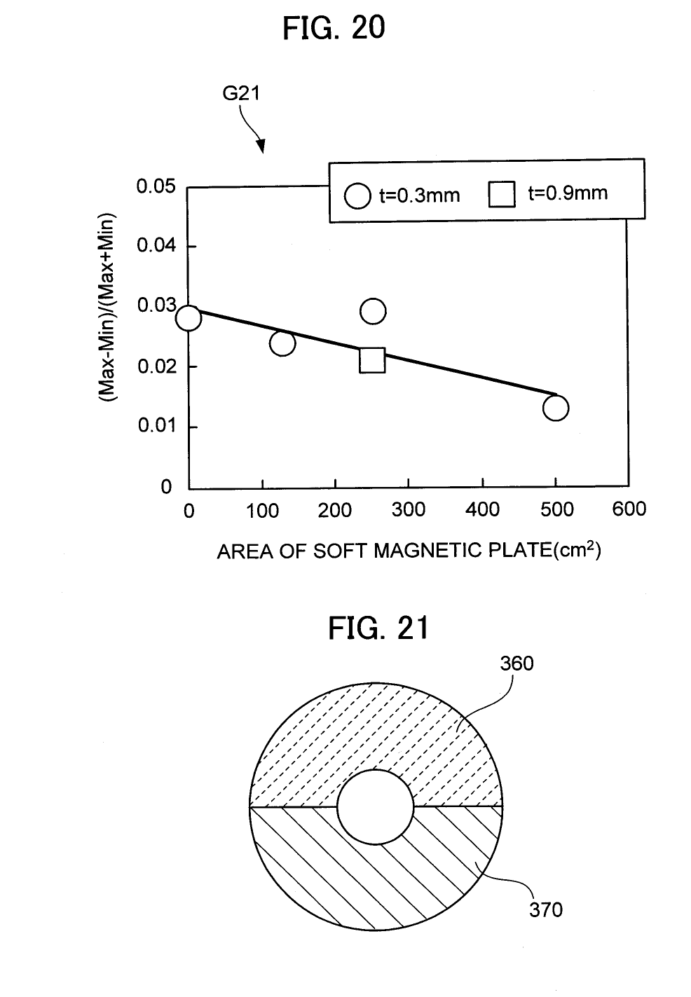

FIG. 20 is a graph plotting the uniform film thickness distribution obtained in the five kinds of experimental structures.

In a graph G21 in FIG. 20, the horizontal axis depicts the fan-shaped areas of the soft magnetic plates used in the experimental structures, and the vertical axis depicts the uniformities of the circumferential-direction film thickness distributions. In the graph G21, the uniformities of the film thickness distributions are represented by values obtained by the following formula.

Uniformity of film thickness distribution=(Max−Min)/(Max+Min)

Here, “Max” is the maximum value in the circumferential-direction film thickness distribution, while “Min” is the minimum value in the circumferential-direction film thickness distribution. The larger the value obtained by this formula is, the lower the uniformity is, and the smaller the value is, the higher the uniformity is.

In the graph G21, the uniformity of the first structure with no soft magnetic plate, the uniformity of the second structure with one small soft magnetic plate, the uniformity of the third structure with one medium soft magnetic plate, and the uniformity of the fourth structure with one large soft magnetic plate are plotted by circles. In addition, the uniformity of the fifth structure with three stacked medium soft magnetic plates each having a thickness of “0.3 mm” and thus having a thickness of “0.9 mm” in total is plotted by a square.

In the graph G21 in FIG. 20, the uniformity value obtained by the formula for the fourth structure with one large soft magnetic plate having the largest area is the minimum. This result shows that the large soft magnetic plate according to the fourth structure is the optimum soft magnetic plate 360 for deposition carried out by using the rotary magnetron sputtering apparatus 300 of this embodiment illustrated in FIG. 2 under the above deposition conditions of supply power to the target 330, the Ar gas flow rate, the gas pressure and the like.

Thus, an optimum soft magnetic plate selected from the three kinds of soft magnetic plates, i.e., small, medium and large soft magnetic plates, on the basis of the experiment and verification is used for the rotary magnetron sputtering apparatus 300 of this embodiment. Accordingly, in this embodiment, a soft magnetic plate having an appropriate area corresponding to the range in which the film thickness is considered to be thick can be used.

As described above, in the rotary magnetron sputtering apparatus 300 of this embodiment, deposition of a film having a uniform thickness is performed by stacking and disposing a required number of soft magnetic plates 360 on the basis of the experiment and verification. In the rotary magnetron sputtering apparatus 300 of this embodiment, the required number is one.

According to this embodiment, by using the soft magnetic plate 360, deposition of a film having a uniform thickness can easily be performed as explained above.

Here, this embodiment employs the attachment structure in which the soft magnetic plate 360 is fixed to the side wall 301 by the retaining member 302 and the like fixing the rim of the target 330, as described with reference to FIG. 6.

The following feature may be added to the attachment structure, in order to improve attachment stability of the soft magnetic plate 360.

FIG. 21 is a schematic view illustrating a structure for improving the attachment stability of the soft magnetic plate 360.

In FIG. 21, a non-magnetic plate 370 which transmits the magnetic field toward the target 330 almost without changing the intensity is disposed in the region between the bottom of the recess 301a of the side wall 301 and the target 330 excluding the region in which the soft magnetic plate 360 is disposed. With the structure using the non-magnetic plate 370, the instability of the soft magnetic plate 360 can be reduced, and the attachment stability can be improved, without affecting the magnetic field toward the target 330.

This indicates that an applied aspect that “the sputtering apparatus further includes a non-magnetic plate that is inserted between the target and the magnetic field generator, and that occupies a region between the target and the magnetic field generator excluding a region occupied by the magnetic plate” is preferable to the basic aspect.

The non-magnetic plate 370 illustrated in FIG. 21 corresponds to an example of the non-magnetic plate in the applied aspect.

Hereinabove, the embodiment in which the magnetic field intensity is weakened by using the soft magnetic plate 360 having a uniform thickness has been described. However, if it is true that the non-uniformity of the film thickness when the magnetic field is uniform is attributable to the high gas pressure on the Ar gas supply port 312 side, the upper part of the film having a large thickness is considered to be increasingly thick toward the supply port 312. For this reason, by using a soft magnetic plate having a thickness becoming increasingly large toward the supply port 312, deposition of a film having a further uniform thickness is considered to be possible.

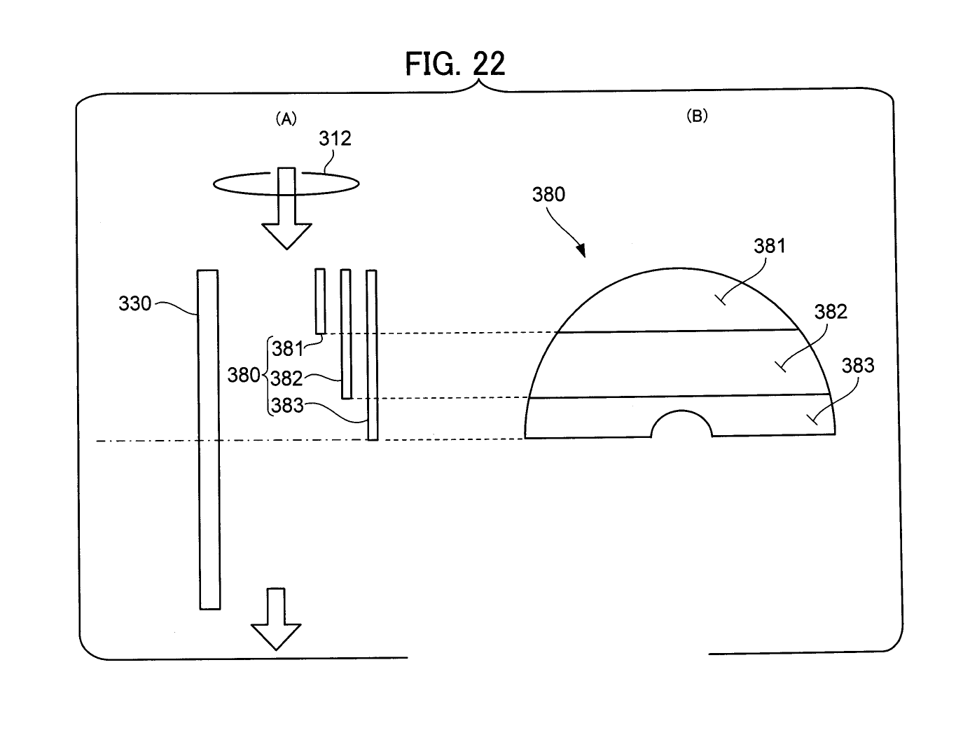

FIG. 22 is a schematic view illustrating an example of a soft magnetic plate having a thickness becoming increasingly large toward the supply port.

Part (A) of FIG. 22 is a side view of a soft magnetic plate 380 having a thickness becoming large toward the supply port 312, together with the target 330; part (B) of FIG. 22 is a front view of the soft magnetic plate 380.

The soft magnetic plate 380 illustrated in FIG. 22 is formed of three kinds of soft magnetic plates 381, 382 and 383 having different sizes and stacked in such a manner that the number of stacked plates becomes large toward the supply port 312.

Of the three kinds of soft magnetic plates forming the soft magnetic plate 380 illustrated in FIG. 22, the largest soft magnetic plate 383 is equivalent to the large soft magnetic plate 363 having a semicircular shape illustrated in FIG. 8, and the medium soft magnetic plate 382 stacked on the largest soft magnetic plate 383 and the smallest soft magnetic plate 381 stacked on the medium soft magnetic plate 382 are each obtained by dividing a semicircular soft magnetic plate into two as follows.

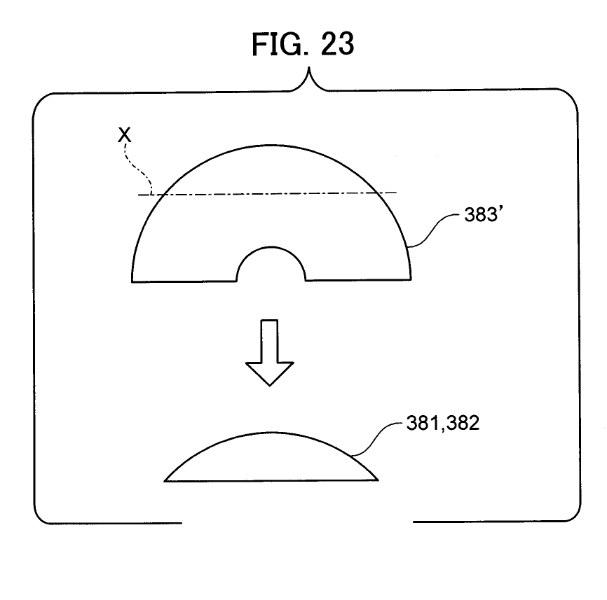

FIG. 23 is a schematic view illustrating a state in which a semicircular soft magnetic plate is divided into two to obtain the medium and the smallest soft magnetic plates illustrated in FIG. 22.

As illustrated in FIG. 23, the medium soft magnetic plate 382 and the smallest soft magnetic plate 381 illustrated in FIG. 22 are each an arc-shaped soft magnetic plate which is an arc side part of the two parts obtained by dividing a semicircular soft magnetic plate 383′ equivalent to the largest soft magnetic plate 383 into two by a cutting-plane line X crossing the radius of the soft magnetic plate 383′ along a base.

By using such arc-shaped soft magnetic plates, the magnetic field from the RMC 340 can be weakened to different extents in an inside part which is on the center side of the base of the arc shape and an outside part which is on the arc side of the base.

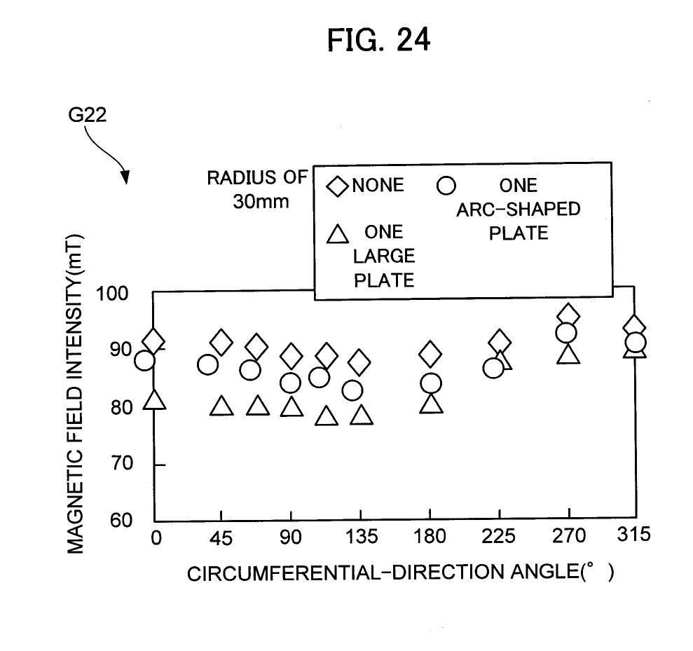

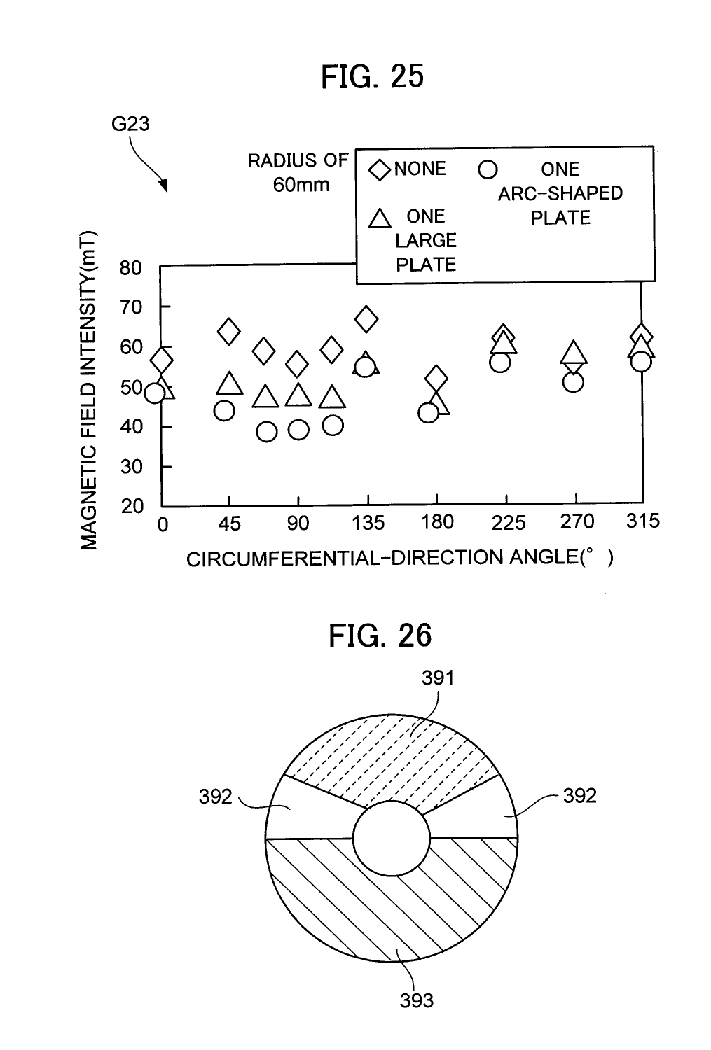

FIG. 24 is a graph depicting the intensity distribution in the inner part when the magnetic field is weakened by using the arc-shaped soft magnetic plates; FIG. 25 is a graph depicting the intensity distribution in the outer part when the magnetic field is weakened by using the arc-shaped soft magnetic plates.

In these graphs, for comparison, the magnetic field intensity distribution with no soft magnetic plate and the magnetic field intensity distribution when the magnetic field is weakened by a semicircular soft magnetic plate equivalent to the largest soft magnetic plate 383 are also depicted.

In a graph G22 in FIG. 24, magnetic field intensities at 10 measurement points aligned on the circumference having a distance of “30 mm” from the disk center illustrated in FIG. 10 described above are plotted as the intensity distribution of the inner part. In a graph G23 in FIG. 25, magnetic field intensities at 10 measurement points aligned on the circumference having a distance of “60 mm” from the disk center are plotted as the intensity distribution of the outer part.

In the graphs G22 and G23, the magnetic field intensity distribution with no soft magnetic plates is plotted by diamonds, the magnetic field intensity distribution when the magnetic field is weakened by the semicircular soft magnetic plate is plotted by triangles, and the magnetic field intensity distribution when the magnetic field is weakened by the arc-shaped soft magnetic plates is plotted by circles.

In the inner part, since the magnetic field from the RMC 340 passes outside the arc-shaped soft magnetic plates, a magnetic field intensity distribution approximately the same as that with no soft magnetic plate is obtained. By contrast, in the outer part, the magnetic field passes the soft magnetic plates, so that the intensity is lower around a position having a circumferential-direction angle of “90°”.

The soft magnetic plate 380 illustrated in FIG. 22 is formed by stacking, on the largest semicircular soft magnetic plate 383, the medium arc-shaped soft magnetic plate 382 and the smallest arc-shaped soft magnetic plate 381, which reduce the magnetic intensity as described above, in such a manner illustrated in part (B) of FIG. 22 that the rims would overlap with each other while the bases are parallel to each other. With this layered structure, the soft magnetic plate 380 has a thickness corresponding to the thickness of three plates at the part closest to the supply port 312, the thickness of two plates at the middle part, and the thickness of one plate at the part farthest from the supply port 312.

With this structure, an effect corresponding to one plate is obtained for a reduction in the magnetic field in the part on the inner side of the base of the medium soft magnetic plate 382, an effect corresponding to two plates is obtained for a reduction in the magnetic field in the part on the outer side of the base of the medium soft magnetic plate 382 and on the inner side of the base of the smallest soft magnetic plate 381, and an effect corresponding to three plates is obtained for a reduction in the magnetic field in the part on the outer side of the base of the smallest soft magnetic plate 381. As a result, such an intensity distribution that the magnetic field becomes weaker toward the supply port 312 even within the region in which the magnetic field is weakened by the soft magnetic plate 380. Thus, deposition of a film having a further uniform thickness is possible.

This indicates that an applied aspect that “the sputtering apparatus further includes a chamber that includes a main body in an inside of which the substrate holding section and the target are housed, and the inside of which is filled with the atmosphere of the predetermined gas; and a supply port from which the predetermined gas is supplied to the inside of the main body, wherein the magnetic plate has a thickness that is thicker on the supply port side than on the other side”, and also an applied aspect that “the sputtering apparatus further includes a chamber that includes: a main body in an inside of which the substrate holding section and the target are housed, and the inside of which is filled with the atmosphere of the predetermined gas; and a supply port from which the predetermined gas is supplied to the inside of the main body, wherein the magnetic plate has a layered structure in which multiple magnetic plates having different sizes from each other are stacked, and the number of layers in the layered structure is larger on the supply port side than on the other side” are preferable to the basic aspect.

The soft magnetic plate 380 in the example of FIG. 22 corresponds to an example of the magnetic plates of these two applied aspects.

Although the structure with one soft magnetic plate disposed on a single plane has been described above, the following disposition is also conceivable in order to perform deposition of a film having a further uniform thickness by allowing the magnetic field intensities to gradually change in the circumferential direction. Specifically, multiple kinds of soft magnetic plates having different effects of weakening the magnetic field are disposed on a single plane.

FIG. 26 illustrates a state in which multiple kinds of soft magnetic plates having different effects of weakening the magnetic field are disposed on a single plane.

In FIG. 26, three kinds of soft magnetic plates 391, 392 and 393 having different saturation magnetizations Ms are disposed on a plane. In general, a larger saturation magnetization Ms brings about a larger effect of weakening the magnetic field. In FIG. 26, the following magnetic plates are prepared: one first soft magnetic plate 391 having the largest saturation magnetization Ms and thus the largest effect of weakening the magnetic field; two second magnetic plates 392 having a medium level saturation magnetization Ms and thus a medium level of effect of weakening the magnetic field; and one third magnetic plate 393 having the smallest saturation magnetization Ms and thus the smallest effect of weakening the magnetic field. Here, in the example in FIG. 26, the first soft magnetic plate 391 has a fan shape of the same size as that of the medium soft magnetic plate 362 illustrated in FIG. 8, the second soft magnetic plates 392 have a fan shape of the same size as that of the small soft magnetic plate 363 illustrated in FIG. 8, and the third soft magnetic plate 393 has a semicircular shape of the same size as that of the large soft magnetic plate 361 illustrated in FIG. 8.

First, the first soft magnetic plate 391 is disposed on the upper side (Ar gas supply port 312 side) where the film tends to be thick at the time of deposition under a uniform magnetic field. The third soft magnetic plate 391 is disposed on the lower side where the film tends to be thin at the time of deposition under a uniform magnetic field. Then, the two second soft magnetic fields 392 are disposed so as to fill the spaces between the two kinds of soft magnetic plates. With this disposition, the largest effect of weakening the magnetic field is obtained on the upper side, and the effect becomes smaller toward the lower side.

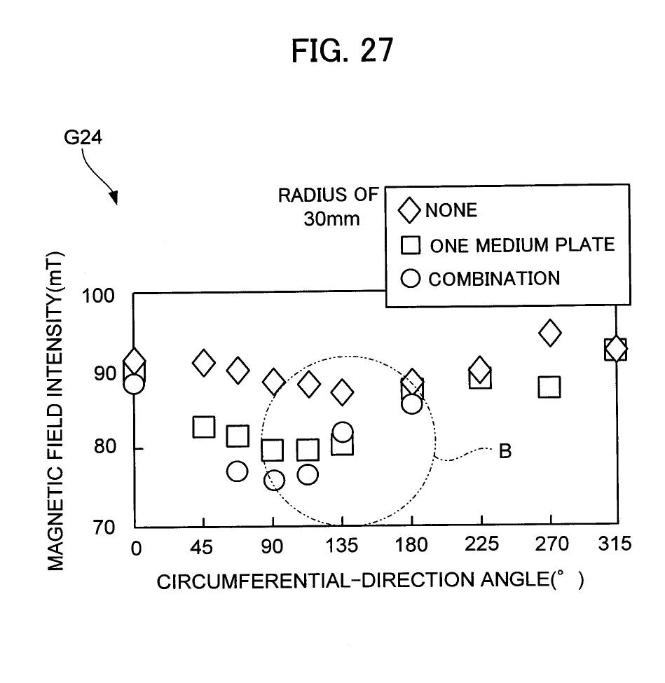

FIG. 27 is a graph depicting magnetic field intensity distribution obtained by the arrangement of the three kinds of soft magnetic plates illustrated in FIG. 26.

In a graph G24 in FIG. 27, the magnetic field intensity distribution with no soft magnetic plate and the magnetic field intensity distribution when the magnetic field is weakened by the medium soft magnetic plate 362 equivalent to the first soft magnetic plate 391 are also depicted for comparison.

In the graph G24 in FIG. 27, the magnetic field intensity distribution with no soft magnetic plate is depicted by diamonds, the magnetic field intensity distribution when the magnetic field is weakened by the medium soft magnetic plate 362 is depicted by squares, and the magnetic field intensity distribution when the magnetic field is weakened by using the arrangement of the three kinds of soft magnetic plates is plotted by circles.

From a comparison between the intensity distribution when the magnetic field is weakened by the medium soft magnetic plate 362 and the intensity distribution when the magnetic field is weakened by using the arrangement of the three kinds of soft magnetic plates, it is understood that the change of the magnetic field intensities in the circumferential-direction angle is more gentle in the latter intensity distribution, which is especially seen in a range B surrounded by a dotted line in the graph G24. This indicates that deposition of a film having a further uniform thickness is possible by using the arrangement of the three kinds of soft magnetic plates illustrated in FIG. 26.

When the target is made of a magnetic material, an effect equivalent to that obtained by the basic aspect can be obtained by employing the following shape for the target, without using the magnetic plate in the basic aspect.

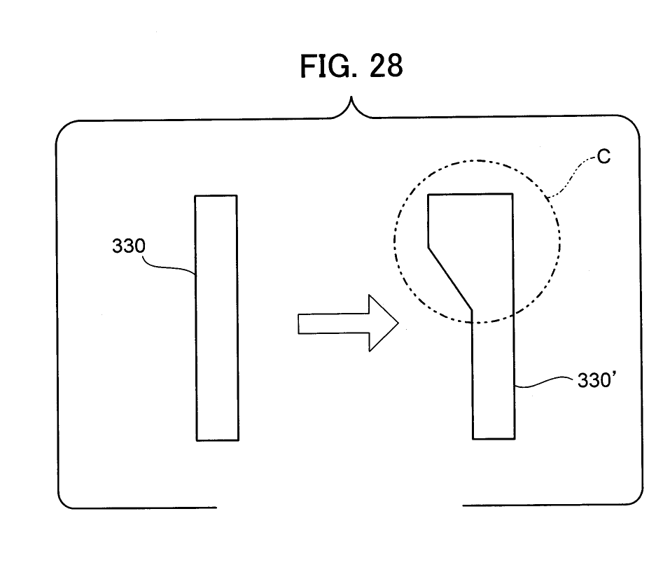

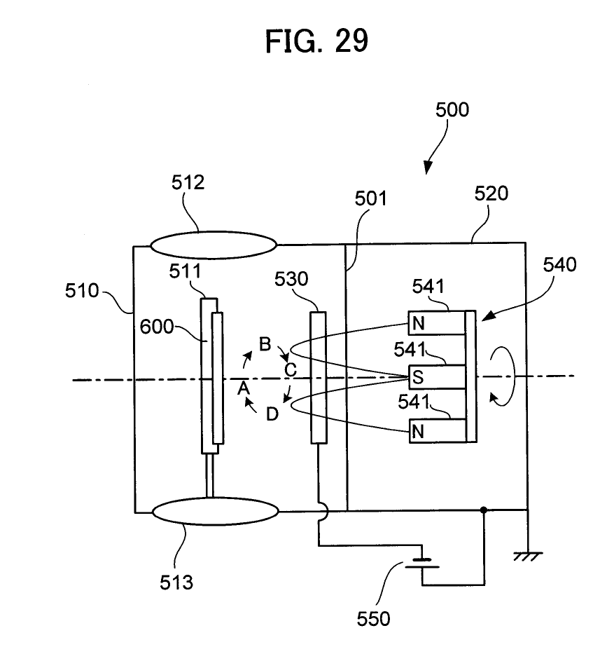

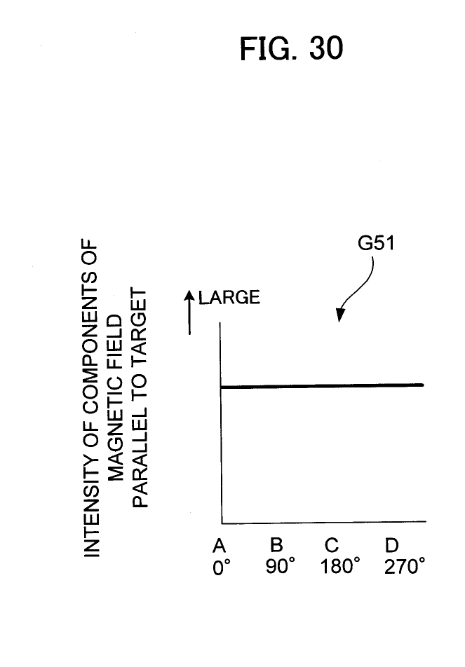

FIG. 28 illustrates the shape of the target which enables deposition of a film having a uniform thickness.

In the example in FIG. 28, instead of the target 330 having a uniform thickness used in the sputtering apparatus 300 in FIG. 2, a target 330′ is used. The target 330′ has a larger thickness on the upper side, as indicated by a range C surrounded by a dotted line in FIG. 28, where the film tends to be thicker in deposition under a uniform magnetic field. Here, the target 330′ is a target for magnetic film formation made by a magnetic material. As described above, in the rotary magnetron sputtering apparatus, the magnetic field generated by the RMC passes the target and then reaches the substrate side of the target where deposition is to be performed. When the target 330′ made of a magnetic material is used, the magnetic field is weakened at the time of passing the target 330′, and the part having a larger plate thickness has a larger effect of weakening the magnetic field. The target 330′ illustrated in FIG. 28 has a larger plate thickness on the upper side where the film tends to be thicker in deposition. Accordingly, the magnetic field passing this part is weakened to a large extent, and thereby the film on a part of the deposition target substrate corresponding to this part is prevented from being too thick. Thus, deposition of a film having a uniform thickness can be achieved.

This indicates that an objective of easily depositing a film having a uniform thickness can also be achieved by using a sputtering apparatus and a sputtering method according to another aspect described below.

According to another aspect of the invention, a sputtering apparatus including:

a substrate holding section that holds a substrate on a surface of which a film is to be formed;

a target in a plate shape that is made of a material of the film and that is disposed in a position facing the surface of the substrate in an atmosphere of a predetermined gas;

a magnetic field generator that is disposed on a side, opposed to the substrate side, of the target, that generates a magnetic field having an arc shape with a vertex reaching the substrate side, and that rotates the magnetic field along the target; and

a power source that applies, to the target, voltage of a polarity causing ions of the predetermined gas to head for the target, wherein

the target has a thickness that is thicker on a part thereof corresponding to a rotation path of the magnetic field than on the other part.

In addition, according to another aspect of the invention, a sputtering method performed in a sputtering apparatus including: a substrate holding section that holds a substrate on a surface of which a film is to be formed; a target in a plate shape that is made of a material of the film and that is disposed in a position facing the surface of the substrate in an atmosphere of a predetermined gas; a magnetic field generator that is disposed on a side, opposed to the substrate side, of the target, that generates a magnetic field having an arc shape with a vertex reaching the substrate side, and that rotates the magnetic field along the target; and a power source that applies, to the target, voltage of a polarity causing ions of the predetermined gas to head for the target, the method including:

disposing, as the target, a target made of a magnetic material and having a thickness that is thicker on a part thereof corresponding to the rotation path of the magnetic field than on the other part; and

applying the voltage to the target by the power source to cause the ions of the predetermined gas to head for the target.

Although the soft magnetic plate 360 weakening the magnetic field on the upper side in FIG. 2 among the magnetic fields near the target 330 is described above as an example of the magnetic plates in the basic aspect and the applied aspect, the soft magnetic plates in the basic aspect and the applied aspect are not limited to the soft magnetic plate 360, and may be a soft magnetic plate which weakens the magnetic field, for example, on the upper side, the depth direction front side or the depth direction back side or the like of the FIG. 2, among the magnetic fields, depending on the non-uniformity of the actual circumferential-direction film thickness distribution.

Moreover, the soft magnetic plate 360 selected from the three kinds of soft magnetic plates, i.e., small, medium and large soft magnetic plates, is described above as an example of the magnetic plates in the basic aspect and the applied aspect. However, the soft magnetic plates in the basic aspect and the applied aspect are not limited to the soft magnetic plate 360, and may be a single soft magnetic plate designed precisely on the basis of the apparatus characteristics of the sputtering apparatus, or may be one selected from two kinds of soft magnetic plates or three or more kinds of soft magnetic plates, for example.

Furthermore, the soft magnetic plate 360 disposed in the airtight chamber for deposition is described above as an example of the magnetic plates in the basic aspect and the applied aspect. However, the soft magnetic plates in the basic aspect and the applied aspect are not limited to the soft magnetic plate 360, and may be disposed outside the chamber to be able to be easily replaced with another soft magnetic plate, for example.

As described hereinabove, the present invention can provide a sputtering apparatus capable of easily depositing a film having a uniform thickness, a sputtering method performed in such a sputtering apparatus, and a method of manufacturing a magnetic recording medium using the sputtering method.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A sputtering apparatus comprising:
a substrate holding section that holds a substrate on a surface of which a film is to be formed;
a target in a plate shape that is made of a material of the film and that is disposed in a position facing the surface of the substrate in an atmosphere of a predetermined gas;
a magnetic field generator that is disposed on a side, opposed to the substrate side, of the target, that generates a magnetic field having an arc shape with a vertex reaching the substrate side, and that rotates the magnetic field along the target;
a power source that applies, to the target, voltage of a polarity causing ions of the predetermined gas to head for the target; and
a magnetic plate that is inserted between the target and the magnetic field generator and that limits the magnetic field reaching the target at a part of a rotation path of the magnetic field.

2. The sputtering apparatus according to claim 1, further comprising a chamber that comprises: a main body in an inside of which the substrate holding section and the target are housed, and the inside of which is filled with the atmosphere of the predetermined gas; and a supply port from which the predetermined gas is supplied to the inside of the main body, wherein
the magnetic plate limits the magnetic field reaching the target at a part of the rotation path of the magnetic field on the supply port side.

3. The sputtering apparatus according to claim 1, further comprising a non-magnetic plate that is inserted between the target and the magnetic field generator, and that occupies a region between the target and the magnetic field generator excluding a region occupied by the magnetic plate.

4. The sputtering apparatus according to claim 1, further comprising a chamber that comprises: a main body in an inside of which the substrate holding section and the target are housed, and the inside of which is filled with the atmosphere of the predetermined gas; and a supply port from which the predetermined gas is supplied to the inside of the main body, wherein
the magnetic plate has a thickness that is thicker on the supply port side than on the other side.

5. The sputtering apparatus according to claim 1, further comprising a chamber that comprises: a main body in an inside of which the substrate holding section and the target are housed, and the inside of which is filled with the atmosphere of the predetermined gas; and a supply port from which the predetermined gas is supplied to the inside of the main body, wherein
the magnetic plate has a layered structure in which multiple magnetic plates having different sizes from each other are stacked, and
the number of layers in the layered structure is larger on the supply port side than on the other side.

6. The sputtering apparatus according to claim 1, wherein the magnetic plate is made of a soft magnetic material.

7. The sputtering apparatus according to claim 1, further comprising a magnetic plate holding section that detachably holds the magnetic plate.

8. A sputtering method performed in a sputtering apparatus comprising: a substrate holding section that holds a substrate on a surface of which a film is to be formed; a target in a plate shape that is made of a material of the film and that is disposed in a position facing the surface of the substrate in an atmosphere of a predetermined gas; a magnetic field generator that is disposed on a side, opposed to the substrate side, of the target, that generates a magnetic field having an arc shape with a vertex reaching the substrate side, and that rotates the magnetic field along the target; and a power source that applies, to the target, voltage of a polarity causing ions of the predetermined gas to head for the target, the method comprising:
disposing a magnetic plate between the target and the magnetic field generator in a position facing a region on the substrate where a film would have a relatively large thickness, the magnetic plate limiting the magnetic field reaching the target at a part of a rotation path of the magnetic field; and
applying the voltage to the target by the power source to cause the ions of the predetermined gas to head for the target.

9. A magnetic recording medium manufacturing method of depositing a magnetic film on a substrate held by a substrate holding section, the method comprising:
disposing a magnetic plate between a target in a plate shape and a magnetic field generator in a position facing a region on the substrate where a film would have a relatively large thickness, the target being made of a material of the magnetic film and being disposed in a position facing a surface of the substrate in an atmosphere of a predetermined gas, the magnetic field generator being disposed on a side, opposed to the substrate side, of the target; and
depositing the magnetic film on the substrate by sputtering in such a manner that a magnetic field having an arch shape reaching the substrate side of the target is generated by the magnetic field generator and that ions are caused to head for the target by applying, to the target, voltage of a polarity causing the ions of the predetermined gas to head for the target while rotating the magnetic field along the target, wherein
the magnetic plate limits the magnetic field reaching the target at a part of a rotation path of the magnetic field.
